(19) United States
(12) Patent Application Publication
(10) Pub. No.: US 2008/0111528 A1
(43) Pub. Date: May 15, 2008

(54) DRIVING DEVICE AND SWITCHING CIRCUIT THEREOF

(75) Inventor: Chia-Wei Wang, Taipei City (TW)

Correspondence Address: J C PATENTS, INC., 4 VENTURE, SUITE 250, IRVINE, CA, 92618, US

(73) Assignee: BEYOND INNOVATION TECHNOLOGY CO., LTD., Taipei City (TW)

(21) Appl. No.: 11/669,413

(22) Filed: Jan. 31, 2007

(30) Foreign Application Priority Data
Oct. 27, 2006 (TW) 95139748

(51) Int. Cl. G05F 1/00

(52) U.S. Cl. 323/282

(57) ABSTRACT

A driving device suitable for receiving a power to drive a load is provided. The driving device includes a switching circuit and a power converting circuit. The switching circuit is coupled to the power and has a control terminal to receiving a first control signal. The power converting circuit is coupled to the switching circuit and transforms the power into a drive signal to drive the load according to a second control signal. The switching circuit determines whether or not to provide the power to the power converting circuit according the first control signal.

### CROSS-REFERENCE TO RELATED APPLICATION

This application claims the priority benefit of Taiwan application serial no. 95139748, filed Oct. 27, 2006. All disclosure of the Taiwan application is incorporated herein by reference.

### BACKGROUND OF THE INVENTION

1. Field of the Invention

The present invention relates to a driving device and a switching circuit thereof, and more particularly to a driving device for a light emitting diode and a switching circuit thereof.

2. Description of Related Art

Generally speaking, the driving circuit of a light emitting diode mainly includes a driving device for providing a stable power to the light emitting diode. Referring to FIG. 1, a circuit diagram of a conventional driving device is shown, the driving device is used to drive a load 110, and the driving device includes a power transformer 100, a control unit 120, and a load indicator 130. The power transformer 100 has an inductor 101, a switch 105, and an output capacitor 107. The load indicator 130 is used to detect the current amount of the load 110, and send a detection signal FB to the control unit 120. The control unit 120 outputs a control signal to the switch 105 to control whether or not to turn on and adjusts an output voltage VOUT through the switch 105 according to the detection signal FB.

Referring to FIG. 1, when the driving device is not activated, the switch 105 is turned off. Though a working current for driving the load 110 is not generated, a current loop has already been formed. The current loop starts from the positive pole of an input voltage VIN, passes through the inductor 101, flows through a Schottky diode 103 coupled to the inductor 101, passes through the load 110, and then is gathered to return to the negative pole of the input voltage VIN. In such a manner, a closed path exists in the conventional driving device, which causes the occurrence of current leakage. Therefore, in the conventional driving device, if the input voltage VIN is connected to a DC power, no matter the switch 105 in the circuit of the driving device is turned on or turned off, the DC power will discharge due to a leakage current loop, which causes additional power consumption. Therefore, how to eliminate the above problems is an important issue.

### SUMMARY OF THE INVENTION

The present invention is directed to a driving device capable of reducing the possibility of current leakage.

As embodied and broadly described herein, the present invention provides a driving device suitable for receiving a power to drive a load, which comprises a switching circuit and a power converting circuit. The switching circuit is coupled to the power and has a control terminal for receiving a first control signal. The power converting circuit is coupled to the switching circuit, and transforms the power into a drive signal to drive the load according to a second control signal. The switching circuit is able to determine whether providing the power to the power converting circuit according to the first control signal.

In another aspect, the present invention is also directed to a second type of driving device suitable for receiving a power to drive a load, which comprises a power converting circuit and a switching circuit. The power converting circuit receives the power to generate a drive signal. The switching circuit is coupled between the power converting circuit and the load, and the switching circuit determines whether or not to turn on the switching circuit according to a first control signal.

In another aspect, the present invention is further directed to a third type of driving device suitable for receiving a power to drive a load, which comprises a power converting circuit and a switching circuit. The power converting circuit receives the power to generate a drive signal to the load. The switching circuit is coupled between the load and a ground terminal, and the switching circuit determines whether or not to turn on the switching circuit according to a first control signal.

In view of the above, the present invention may avoid the formation of a closed path between the driving circuit and the load when the load is not required to be driven by the switching circuit, and thus no power is provided to the load. Therefore, the present invention can reduce the current leakage effectively.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional driving device.

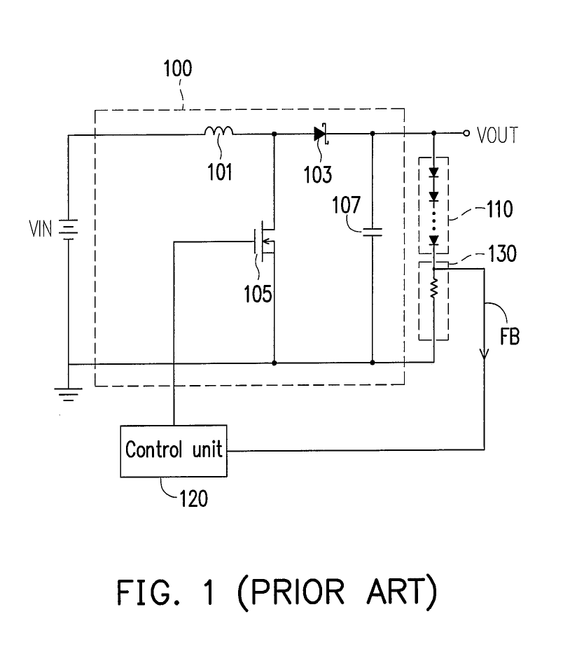

FIG. 2 is a circuit diagram of a driving device according to a preferred embodiment of the present invention.

FIG. 3 is a timing diagram of a control signal according to a preferred embodiment of the present invention.

FIG. 4 is a circuit diagram of a second type of driving device according to a preferred embodiment of the present invention.

FIG. 5 is a circuit diagram of a third type of driving device according to a preferred embodiment of the present invention.

### DESCRIPTION OF EMBODIMENTS

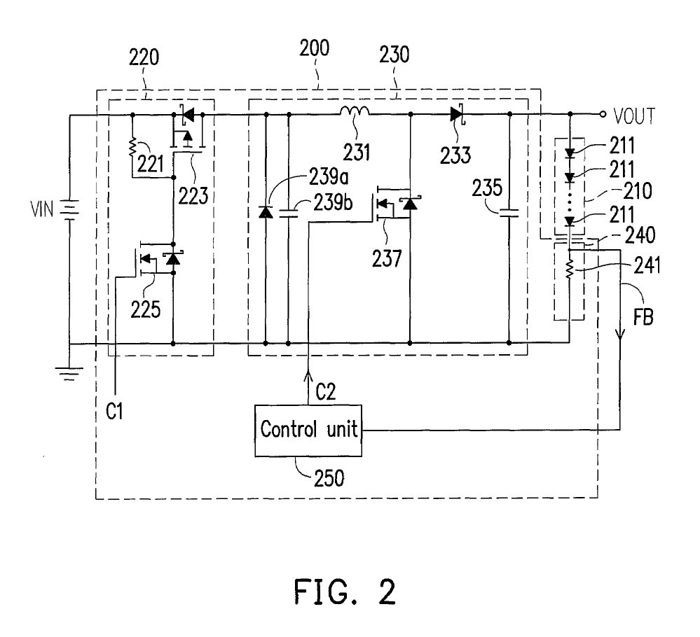

Referring to FIG. 2, a circuit diagram of a driving device according to an embodiment of the present invention is shown. The driving device 200 includes a switching circuit 220 and a power converting circuit 230. The switching circuit 220 is coupled to an input voltage VIN, and determines whether or not to provide the input voltage VIN to the power converting circuit 230 according to a control signal C1. The power converting circuit 230 transforms the input voltage VIN into a drive signal VOUT to drive a load 210 according to a control signal C2. In this embodiment, the control signal C1 may be a chip enable signal or an external control signal (e.g., provided by an external circuit), or the like, which is not limited in the present invention, and in this embodiment, the chip enable signal is taken as an example.

In this embodiment, the load 210 includes a plurality of light emitting diodes 211. Taking this embodiment as an example, in the load 210, a cathode terminal of each light emitting diode 211 is coupled to an anode terminal of next light emitting diode 211.

The switching circuit 220 of this embodiment includes two switches 223 and 225. A first terminal of the switch 223 is coupled to the input voltage VIN, and a second terminal of the switch 223 is coupled to power converting circuit 230 through the output terminal of the switching circuit 220. A control terminal of the switch 225 receives the control signal C1 and determines whether or not to turn on the switch 223 according to the control signal C1, so as to turn on the input voltage VIN and provide the input voltage VIN to the power converting circuit 230. Additionally, the power converting circuit 230 transforms the input voltage VIN into the voltage VOUT to drive the load 210.

Generally speaking, the switching circuit 220 is not necessarily implemented by two switch elements, and those skilled in the art should understand that the switching circuit 220 can also be implemented by one switch element. In this embodiment, the switching circuit 220 is implemented by tow switch elements. The switch 223 can be implemented by a PMOS transistor, which has a first source/drain terminal coupled to the input voltage VIN, and coupled to a gate terminal thereof through a resistor 221. In addition, a second source/drain terminal of the PMOS transistor 223 is coupled to the power converting circuit 230. Moreover, the switch 225 may be implemented by an NMOS transistor, which has a first source/drain terminal grounded, a gate terminal for receiving the control signal C1, and a second source/drain terminal coupled to the gate terminal of the PMOS transistor 223.

Referring to FIG. 2, the power converting circuit 230 of this embodiment includes an inductor 231, a switch 237, a rectifying element 233, and an output capacitor 235. One terminal of the inductor 231 is coupled to the second source/drain terminal of the PMOS transistor 223 in the switching circuit 220, and the other terminal of the inductor 231 is grounded through the switch 237. In this embodiment, the control signal C2 is adjusted by the control unit 250 through the operation state of the load indicator 241 according to the change of the load 210. In addition, the rectifying element 233 in this embodiment may also be implemented by a Schottky diode, wherein an anode terminal of the Schottky diode is also grounded through the switch 237, a cathode terminal is grounded through the capacitor 235 and coupled to the load 210.

In order to avoid the transient change of current, the power converting circuit 230 further includes a diode 239a, which has a cathode terminal coupled to the switching circuit 220 together with the inductor 231 and an anode terminal grounded. In addition, a capacitor 239b is disposed at two terminals of the diode. Generally speaking, the diode 239a and the capacitor 239b may exist in the power converting circuit 230 at the same time or one of them selectively exist in the power converting circuit 230.

Moreover, the driving device 200 of this embodiment further includes a load indicator 240 and a control unit 250. In this embodiment, the load indicator 240 includes a resistor 241. The cathode terminal of the last light emitting diode 211 in the load 210 is grounded through the resistor 241. In this manner, the current flowing through the load 210 can be transformed into a detection signal FB in voltage form when flowing through the load indicator 241. The control unit 250 provides the control signal C2 and is coupled to a node where the load 210 and the resistor 241 are coupled. The control unit 250 receives the detection signal FB, and adjusts the control signal C2 according to the detection signal FB, so as to control the power converting circuit 230. In some embodiments, the control unit 250 can be a pulse width modulation unit, which adjusts the control signal C2 according to detection signal FB.

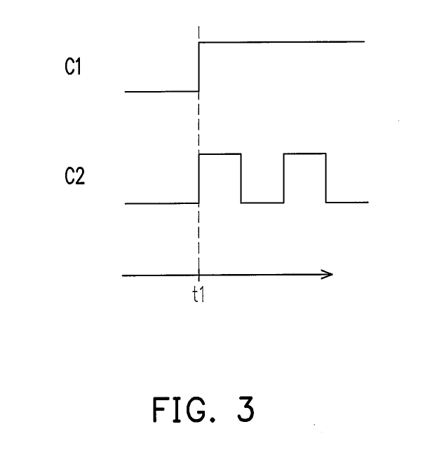

Referring to FIG. 3, a timing diagram of the control signal of FIG. 2 is shown. Referring to FIGS. 2 and 3 together, it can be clearly seen from FIG. 3 that before an initial time t1, as the driving device 200 has not been activated, the control signal C2 is disabled. At this point, in order to avoid the driving device 200 from generating current leakage under influence caused by the input voltage VIN and consuming power, the control signal C1 is thus also disabled, such that no working current flows through the load 210. At this time, the NMOS transistor 225 is turned off, and therefore the PMOS transistor is turned off. Therefore, the switching circuit 220 will not provide the input voltage VIN to the power converting circuit 230 before the initial time t1. In such a manner, the driving device 200 provided by the present invention will not generate current leakage and consume power before being activated.

In this embodiment, the control signal C1 is a chip enable signal. At the initial time t1, the control signal C1 is enabled, and the switching circuit 220 provides the input voltage VIN to the power converting circuit 230, such that the power converting circuit transforms the input voltage VIN into the drive signal VOUT to drive the load 210. At this time, the load indicator 240 also generates the detection signal FB to the control unit 250 according to the current flowing through the load 210, so as to adjust the control signal C2 to the power converting circuit 230, such that the driving device is stably operated.

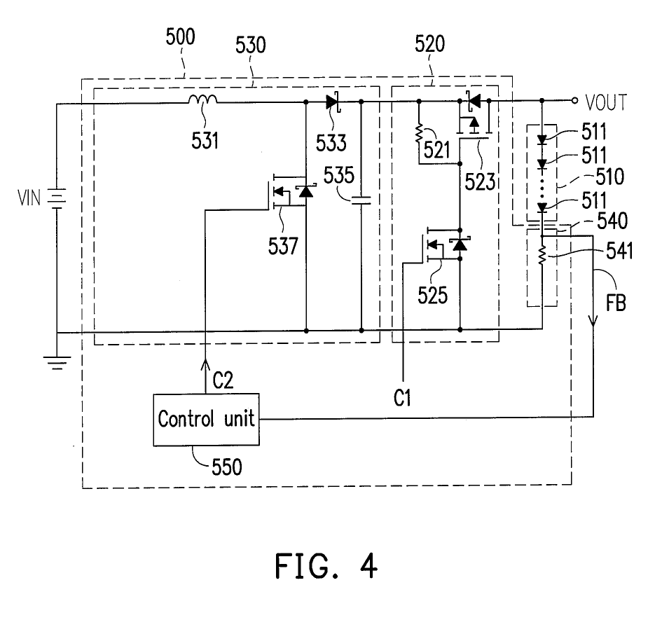

Referring to FIG. 4, a circuit diagram of a second type of driving device according to an embodiment of the present invention is shown. The driving device 500 includes a power converting circuit 530 and a switching circuit 520. The power converting circuit 530 receives the control signal C2 and transforms the input voltage VIN into a drive signal according to the control signal C2, so as to drive the load 510. The switching circuit 520 is coupled to the power converting circuit 530 and the load 510, wherein the switching circuit 520 determines whether or not to turn on the switching circuit 520 to drive the load 510 according to control signal C1. The first control signal C1 may be a chip enable signal or an external control signal, or the like, and in this embodiment, the chip enable signal is taken as an example. In this embodiment, the load 510 includes a plurality of light emitting diodes 511. Taking this embodiment as an example, in the load 510, a cathode terminal of each light emitting diode 511 is coupled to an anode terminal of next light emitting diode 511.

The switching circuit 520 provided by the present invention includes two switches 523 and 525. A first terminal of the switch 523 is coupled to the power converting circuit 530, and a second terminal of the switch 523 is coupled to the load 510 through the output terminal of the switching circuit 520. The switch 525 determines whether or not to turn on the switch 523 according to the control signal C1. In this manner, through the switching circuit 520, the driving device 500 of the present invention may avoid the forming of a closed loop between the power converting circuit 530 and the load 510 before being activated, thus avoiding the generation of current leakage.

Generally speaking, the power converting circuit 530 of this embodiment includes an inductor 531, a switch 537, a rectifying element 533, and an output capacitor 535. One terminal of the inductor 531 is coupled to the input voltage VIN, and the other terminal of the inductor 531 is grounded through the switch 537. In an embodiment of the present invention, the control signal C2 is used to control the operation state of the switch 537. In addition, the rectifying element 533 in this embodiment is implemented by a Schottky diode, wherein an anode terminal of the Schottky diode is also grounded through the switch 537, and a cathode terminal is grounded through the capacitor 535 and coupled to the switching circuit 520.

Still referring to FIG. 4, the switching circuit 520 is not necessarily implemented by two switch elements, and in this embodiment, the switching circuit 520 is implemented by two switch elements. The switch 523 can be implemented by a PMOS transistor, which has a first source/drain terminal coupled to the output terminal of the power converting circuit 530, and coupled to a gate terminal through a resistor 521. In addition, the second source/drain terminal of the PMOS transistor 523 is coupled to the load 510. Moreover, the switch 525 may be implemented by an NMOS transistor, which has a first source/drain terminal grounded, a gate terminal for receiving the control signal C1, and a second source/drain terminal coupled to the gate terminal of the PMOS transistor 523.

The operation manner of the switching circuit 520 of the present invention is the same as that of the switching circuit 220, and the detail description thereof will not be repeated. In other alternative embodiments, the driving device 500 of this embodiment further includes a load indicator 540 and a control unit 550. In this embodiment, the load indicator 540 includes a resistor 541, and the cathode terminal of the last light emitting diode 511 is grounded through the resistor 541. In this manner, the current flowing through the load 510 will be transformed into the detection signal FB in voltage form when flowing through the load indicator 541. The control unit 550 can provide the control signal C2, and is coupled to a node where the load 510 and the resistor 541 are coupled, so as to receive the detection signal FB, and adjust the control signal C2 according to detection signal FB, so as to control the power converting circuit 530. In some embodiments, the control unit 550 may be a pulse width modulation unit.

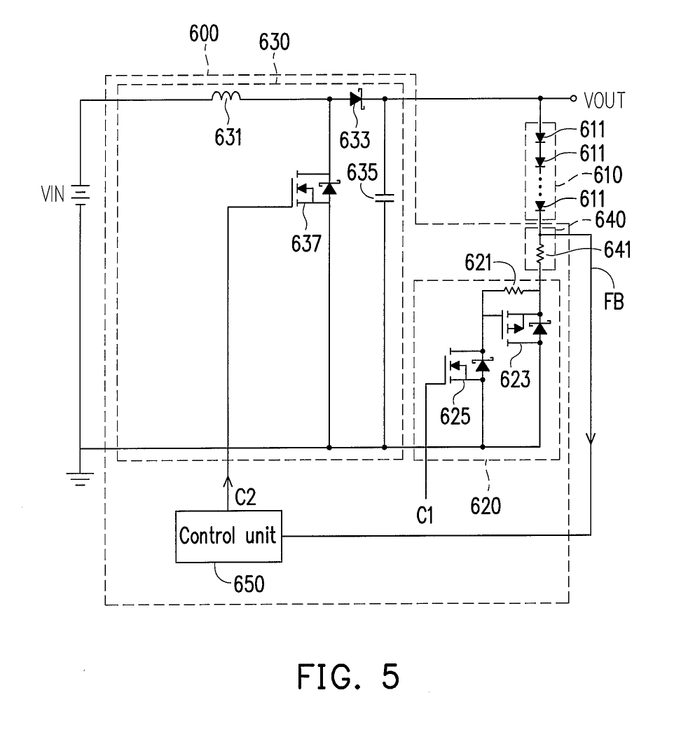

Referring to FIG. 5, a circuit diagram of a third type of driving device according to an embodiment of the present invention is shown. The driving device 600 includes a power converting circuit 630 and a switching circuit 620. The power converting circuit 630 receives the control signal C2 and transforms the input voltage VIN into a drive signal to the load 610 according to the control signal C2, and the components and function thereof are the same as those of the power converting circuit 530, and the details will not be described herein. In addition, the switching circuit 620 is coupled between a load indicator 640 and a ground terminal, wherein the switching circuit 620 determines whether or not to turn on the switching circuit 620 to drive the load 610 according to control signal C1. It should be noted that the switching circuit 620 of this embodiment may be implemented by an NMOS. In addition, the control signal C1 of this embodiment may be a chip enable signal or an external control signal, or the like, which is not limited in the present invention. As described above, through the switching circuit 620, the driving device 600 of the present invention may avoid the forming of a closed loop between the power converting circuit 630 and the load 610 before being activated, and avoid the generation of the leakage current, thus eliminating the problem of current leakage.

In view of the above, through the switching circuit, the present invention may avoid the forming of a closed loop between the driving circuit and the load before driving the load, so as to reduce the generation of current leakage effectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving device, suitable for receiving a power to drive a load, the driving device comprising:
a switching circuit, coupled to the power and having a control terminal to receive a first control signal; and
a power converting circuit, coupled to the switching circuit, for transforming the power into a drive signal to drive the load according to a second control signal, wherein the switching circuit determines whether or not to provide the power to the power converting circuit according to the first control signal.

2. The driving device as claimed in claim 1, wherein the switching circuit further comprises an output terminal and an input terminal, the input terminal is coupled to the power, the control terminal receives the first control signal, and the output terminal is coupled to the power converting circuit.

3. The driving device as claimed in claim 1, wherein the switching circuit comprises:
a first switch, having a first terminal coupled to the power and a second terminal coupled to the output terminal of the switching circuit; and
a second switch, for determining whether or not to turn on the first switch according to the first control signal.

4. The driving device as claimed in claim 3, wherein the first switch comprises a PMOS transistor having a first source/drain terminal coupled to the power, a second source/drain terminal coupled to the output terminal of the switching circuit, and a gate terminal coupled to the first source/drain terminal of the PMOS transistor through a resistor while the second switch comprises a first NMOS transistor having a first source/drain terminal grounded, a gate terminal for receiving the first control signal, and a second source/drain terminal coupled to the gate terminal of the PMOS transistor.

5. The driving device as claimed in claim 1, wherein the first control signal is a chip enable signal.

6. The driving device as claimed in claim 1, wherein the first control signal is an external control signal.

7. The driving device as claimed in claim 1, wherein the power converting circuit comprises:
an inductor, having a first terminal coupled to the output terminal of the switching circuit;
a third switch, determining whether or not to ground a second terminal of the inductor according to the second control signal;
a rectifying element, having a first terminal coupled to the second terminal of the inductor and a second terminal for outputting the drive signal to the load; and
a first capacitor, having a first terminal grounded and a second terminal coupled to the second terminal of the rectifying element, wherein the rectifying element is a Schottky diode, the first terminal is an anode terminal, and the second terminal is a cathode terminal.

8. The driving device as claimed in claim 7, wherein the power converting circuit further comprises a diode having a cathode terminal coupled to the output terminal of the switching circuit and an anode terminal grounded.

9. The driving device as claimed in claim 7, wherein the power converting circuit further comprises a second capacitor having a first terminal grounded and a second terminal coupled to the output terminal of the switching circuit.

10. The driving device as claimed in claim 7, wherein the third switch comprises a second NMOS transistor having a first source/drain terminal grounded, a gate terminal for receiving the second control signal, and a second source/drain terminal coupled to the second terminal of the inductor.

11. The driving device as claimed in claim 7, further comprising:
a load indicator, coupled to the load, for detecting a working current flowing through the load and generating a detection signal; and
a control unit, for generating the second control signal, and coupled to the load indicator for adjusting the second control signal to the power converting circuit according to the detection signal.

12. A driving device, suitable for receiving a power to drive a load, the driving device comprising:
a power converting circuit, for receiving the power to generate a drive signal; and
a switching circuit, coupled to the power converting circuit and the load, wherein the switching circuit determines whether or not to turn on the switching circuit according to a first control signal.

13. The driving device as claimed in claim 12, wherein the switching circuit further comprises a control terminal, an input terminal, and an output terminal, the input terminal is coupled to the power converting circuit, the control terminal receives the first control signal, and the output terminal outputs the drive signal to the load.

14. The driving device as claimed in claim 12, wherein the switching circuit comprises:
a first switch, having a first terminal coupled to the power converting circuit and a second terminal coupled to the output terminal of the switching circuit; and
a second switch, for determining whether or not to turn on the first switch according to the first control signal.

15. The driving device as claimed in claim 14, wherein the first switch comprises a PMOS transistor having a first source/drain terminal coupled to the power converting circuit, a second source/drain terminal coupled to the output terminal of the switching circuit, and a gate terminal coupled to the first source/drain terminal of the PMOS transistor through a resistor while the second switch comprises a first NMOS transistor having a first source/drain terminal grounded, a gate terminal for receiving the first control signal, and a second source/drain terminal coupled to the gate terminal of the PMOS transistor.

16. The driving device as claimed in claim 12, wherein the first control signal is a chip enable signal.

17. The driving device as claimed in claim 12, wherein the power converting circuit comprises:
an inductor, having a first terminal coupled to the power;
a third switch, for determining whether or not to ground the second terminal of the inductor according to a second control signal;
a rectifying element, having a first terminal coupled to the second terminal of the inductor and a second terminal coupled to the input terminal of the switching circuit; and
a first capacitor, having a first terminal grounded and a second terminal coupled to the second terminal of the rectifying element.

18. The driving device as claimed in claim 17, wherein the third switch comprises a second NMOS transistor having a first source/drain terminal grounded, a gate terminal for receiving the second control signal, and a second source/drain terminal coupled to the second terminal of the inductor.

19. The driving device as claimed in claim 12, further comprising:
a load indicator, coupled to the load, for detecting a working current flowing through the load and generating a detection signal; and
a control unit, for providing the second control signal, and coupled to the load indicator for adjusting the second control signal to the power converting circuit according to the detection signal.

20. A driving device, suitable for receiving a power to drive a load, the driving device comprising:
a power converting circuit, for receiving the power to generate a drive signal to the load; and
a switching circuit, coupled to the load and a ground terminal, wherein the switching circuit determines whether or not to turn on the switching circuit according to a first control signal.

21. The driving device as claimed in claim 20, wherein the switching circuit further comprises a control terminal, an input terminal, and an output terminal, the input terminal is coupled to the load, the control terminal receives the first control signal, and the output terminal is coupled to the ground terminal.

22. The driving device as claimed in claim 20, wherein the switching circuit comprises:
a first switch, having a first terminal coupled to the load and a second terminal coupled to the ground terminal; and
a second switch, for determining whether or not to turn on the first switch according to the first control signal.

23. The driving device as claimed in claim 22, wherein the first switch comprises a PMOS transistor having a first source/drain terminal coupled to the load, a second source/drain terminal coupled to the ground terminal, and a gate terminal coupled to the first source/drain terminal of the PMOS transistor through a resistor while the second switch comprises a first NMOS transistor having a first source/drain terminal grounded, a gate terminal for receiving the first control signal, and a second source/drain terminal coupled to the gate terminal of the PMOS transistor.

24. The driving device as claimed in claim 20, wherein the first control signal is a chip enable signal.
